(19) United States
(12) Patent Application Publication
(10) Pub. No.: US 2016/0286975 A1
(43) Pub. Date: Oct. 6, 2016

(54) SIDE SLEEPER MATTRESS

(71) Applicant: Scott J. Breier, Lakewood, OH (US)

(72) Inventor: Scott J. Breier, Lakewood, OH (US)

(21) Appl. No.: 15/184,110

(22) Filed: Jun. 16, 2016

Related U.S. Application Data
(63) Continuation-in-part of application No. 14/497,874, filed on Sep. 26, 2014, now abandoned.
(60) Provisional application No. 61/883,808, filed on Sep. 27, 2013.

(51) Int. Cl. A47C 27/14; B68G 7/12

(52) U.S. Cl. CPC A47C 27/146; B68G 7/12

(57) ABSTRACT

A mattress is disclosed that accommodates a side sleeper. The mattress includes an aperture defined therein and an insert that is disposed in the aperture. The insert includes a channel that receives an upper portion of a person's body.

### CROSS-REFERENCE TO RELATED APPLICATIONS

This application is a Continuation-in-Part of pending U.S. Patent Application Ser. No. 14/497,874 entitled “SIDE SLEEPER MATTRESS” filed on Sep. 26, 2014, which claims the benefit of U.S. Patent Application Provisional Application Ser. No. 61/883,808 entitled “SIDE SLEEPER MATTRESS” filed on Sep. 27, 2013. The entireties of the above-noted applications are incorporated by reference herein. This application, the contents of which are hereby incorporated by reference in their entirety.

### ORIGIN

The field of art disclosed herein pertains to a sleeping mattress and more particularly to a sleeping mattress that conforms to a shape of person.

### BACKGROUND

The act of sleeping is a very important aspect of all individual's everyday lives. On average, the amount of sleep an individual gets totals to be a quarter to a third of the individual's life. Various studies have recently been made on sleeping habits in relation to health, posture, and quality of living. Researchers can all agree that both the amount of sleep, as well as the quality of sleep, has an incredible effect on an individual's well-being. Recent developments in mattresses have tended to focus on conforming to person's body in order to alleviate high pressure contact on small portions of their body. In general, such sleeping mattresses attempt to accommodate individuals with a wide range of sleeping habits. For example, fluid-filled bladders, pneumatically-adjustable bladders, and highly compressible foams have been used in many commercially successful mattress products to address these needs.

However, these generally conforming mattresses do not address specific needs of individuals who sleep on their side. Proper support for the shoulder during sleep can be essential to daily upper-body movements. Individuals that primarily sleep in an orientation perpendicular to the mattress (side sleeping) have sought a solution that allows for greatly reduced/negative pressure in the shoulder region, and that relieve issues the individual may have with their spinal alignment in the upper torso/neck region.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect of the innovation, a mattress is disclosed that includes a mattress body, an aperture defined in the mattress body that is oriented proximate to an upper torso portion of a person, and a contoured insert that is shaped to be received in the aperture, the contoured insert including a channel having a first portion that has a substantially constant width, a second portion at one longitudinal end of the first portion that increases in width as the channel approaches a perimeter of the contoured insert, and a second portion at an opposite longitudinal end of the first portion that increases in width as the channel approaches the perimeter of the contoured insert, the channel being dimensioned to receive an arm and a shoulder of the person.

In another aspect of the innovation, a mattress to support a side sleeping person is disclosed that includes a mattress body having a top substrate and a bottom substrate separated by a resilient layer having a mattress thickness to resiliently conform to a body of a person, an aperture formed in the top substrate and the resilient layer mattress that is oriented proximate to an upper torso portion of the body of the person, and a contoured insert that is shaped to be received in the aperture and having a channel to receive an upper portion of the body of the person.

In still another aspect of the innovation, a method of assembling a mattress to support a side sleeping person is disclosed that includes forming a mattress body having a top substrate, a bottom substrate, and a resilient layer disposed between the top and bottom substrate and having a mattress thickness to resiliently conform to a body of a person, forming an aperture in the top substrate and the resilient layer, and forming an insert that is shaped to be received in the aperture and that comprises a trough-shaped channel that is shaped to correspond to the upper portion of a shoulder and upper arm of the person.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates a perspective view of a mattress having a contoured insert removed from the mattress and that includes an upwardly open recess to receive an upper portion of a person sleeping on the mattress according to one or more embodiments.

FIG. 1A illustrates a close-up view of the innovative contoured insert according to one or more embodiments.

FIG. 2 illustrates a perspective view of an example mattress having two contoured inserts for supporting two persons that are side sleepers according to one or more embodiments.

FIG. 3 illustrates a top view of the mattress of FIG. 2 according to one or more embodiment.

FIG. 4 illustrates a side view of the mattress of FIG. 2 according to one or more embodiments.

FIG. 5 illustrates a side view in longitudinal cross section through lines A-A of FIG. 3 through the contoured insert according to one or more embodiments.

FIG. 6 illustrates a front view in transverse cross section through lines B-B of FIG. 3 through the contoured insert, according to one or more embodiments.

FIG. 7 illustrates a perspective view of the contoured insert of FIG. 1 according to one or more embodiments.

FIG. 8 illustrates a perspective view of the mattress of FIG. 2 with one contoured insert and a flat contoured insert removed according to one or more embodiments.

FIG. 9 illustrates a perspective view of the mattress of FIG. 8 with one contoured insert and a flat insert installed according to one or more embodiments.

FIG. 10 illustrates a perspective view of another example mattress having four apertures that receive a contoured insert and three flat inserts according to one or more embodiments.

FIG. 11 illustrates a perspective view of a further example mattress having two trough-shaped channels formed directly into a top resilient layer according to one or more embodiment.

FIG. 12 illustrates a flow diagram of a method of assembling a mattress having a trough-shaped channel for supporting a side sleeping person according to one or more embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

In one or more aspects of the present disclosure, a side sleeper mattress with extensive health benefits addresses needs of a wide target audience. With over 70% of the world population being side sleepers, many of which having related sleep disturbances and health problems, the side sleeper mattress provides an adjustable indentation in a mattress body for shoulder displacement. The adjustable indentation allows for the individual to sleep on their side without undue pressure on the shoulder or upper torso. By providing this design feature to a traditional sleeping surface, the side sleeper mattress has demonstrated extensive health benefits to include relief from shoulder, neck and back nerve impingement, decreased snoring, relief of sleep apnea, and improved arterial flow.

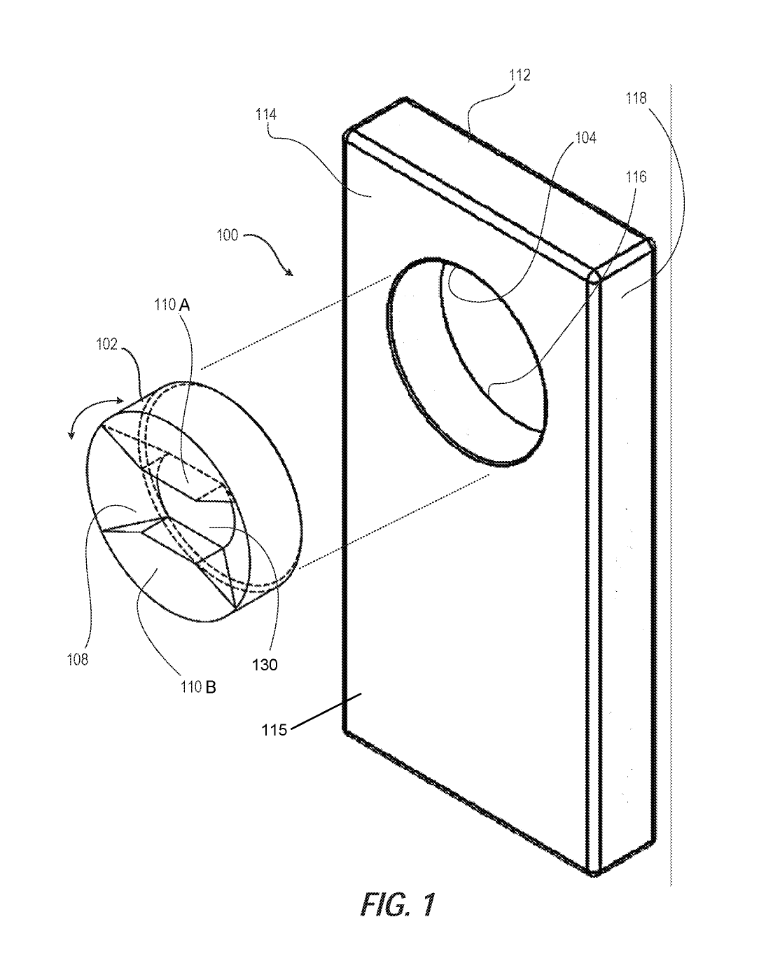

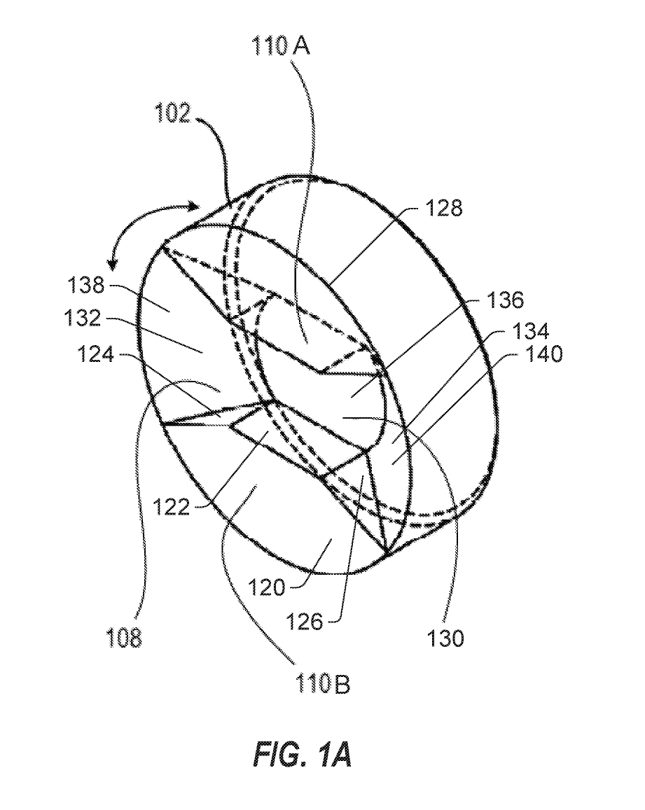

Referring now to the drawings, FIG. 1 illustrates a mattress 100 with a removable innovative contoured insert 102 removed from an aperture 104 defined in the mattress 100 in accordance with an embodiment of the innovation. In example embodiments, the mattress 100 may be any size (e.g., twin, double, queen, king, etc.). As will be described in more detail further below, the insert 102 includes an upwardly open recess 106 to receive an upper portion of a person sleeping on the mattress 100, according to one or more embodiments. The upwardly open recess 106 can be a trough-shaped channel 108 sized and positioned to receive a shoulder, an upper arm, etc. of the person.

The mattress 100 includes a mattress body 112 having a top substrate 114 and a bottom substrate 116 separated by at least one resilient layer 118 to have a mattress thickness that resiliently conforms to a body of a person. In example embodiments, the mattress body 112 can be a selected one of an innerspring mattress, a waterbed mattress, foam mattress, an air bed, etc. The aperture 104 is formed in the mattress body 112 and in one embodiment may extend through the mattress body 112, the top substrate 114, and the bottom substrate 116. In another embodiment, the aperture 104 may extend through the top substrate 114 and the mattress body 112.

In one embodiment, the insert 102 can be removably inserted into the aperture 104 and may be supported by the bottom substrate 116 that serves as a structural layer to support and maintain a vertical position of the insert 102. In an alternate embodiment, the insert 102 can be attached to the mattress body 112 inside the aperture 104. The insert 102 and aperture 104 can be cylindrical, allowing the insert 102 to be rotated to present the trough-shaped channel 108 at a desired orientation. It is to be understood, however, that the shape of the insert and aperture can be any shape (e.g., square, rectangular, oval, etc.). Thus, the shape of the insert and aperture are for illustrative purposes only and are not intended to limit the scope of the innovation.

Referring to FIGS. 1 and 1A, the innovative contoured insert 102 includes a perimeter 128 and, as mentioned above, is configured to be received in the aperture 104 and to receive an upper body portion of the person. The insert 102 includes a pair (first and second) of wedge shaped supports 110A, 110B. The channel 108 is defined between the pair of wedge shaped supports 110A, 110B.

Each of the pair of wedge shaped supports 110A, 110B includes a first surface 120 that is essentially on a same plane as a first surface 115 of the top substrate 114 when the insert 102 is inserted into the aperture 104. Each of the pair of wedge shaped supports 110A, 110B further include a first side wall 122, a second side wall 124, and a third side wall 126. The first side wall 122 of each of the pair of wedge shaped supports 110A, 110B are oppositely opposed (i.e. face each other) and substantially parallel to each other. The second side 124 wall meets or intersects the first side 122 wall at one end of the first side 122 wall and the third side 126 wall meets of intersects the first side 122 wall at an opposite end of the first side wall 122. The second and third side walls 124, 126 of each of the pair of wedge shaped supports 110A, 110B are angled such that the channel 108 increases in width as the channel 108 approaches the perimeter 128 of the insert.

The channel 108 includes a first (middle) portion 130, a second portion (first side portion) 132 defined at one longitudinal end of the first portion 130, and a third portion 134 (second side portion) defined at a second (or opposite) longitudinal end of the first portion 130. The first portion 130 is defined between the first side walls 120 of each of the pair of wedge shaped supports 110A, 110B, has width that is essentially constant, and includes a substantially flat bottom surface (floor) 136. Thus, a depth of the first portion 130 of the channel 108 is substantially constant. In other words, the bottom surface 136 of the first portion 130 of the channel 108 is essentially flat and essentially parallel to the first surface 120 of the first and second wedge shaped supports 110A, 110B and essentially parallel to the first surface 115 of the top substrate 114.

The second and third portions 132, 134 of the channel 108 have a width that increases as the channel 108 approaches the perimeter 128 of the insert. Thus, the second and third portions 132, 134 form wider cavities on each longitudinal end of the channel 108. Further, the second and third portions 132, 134 have a depth that is essentially the same as the depth of the first portion 130 where the second and third side walls 124, 126 meet with the first side wall 122. The depth of the second and third portions 132, 134 of the channel 108, however, decreases as the channel 108 approaches the perimeter 128 of the insert 102. Thus, a bottom surface (floor) 138, 140 of the second and third portions 132, 134 slopes in a downward direction from the perimeter 128 toward the bottom surface 136 of the first portion 130 of the channel 108.

The configuration of the contoured insert 102 facilitates placement of the upper body (e.g., shoulder, arm, upper torso, etc.) portion into the insert. More specifically, the contoured insert 102 allows a side sleeper to comfortably rest their arm in the channel while having their shoulder slightly elevated.

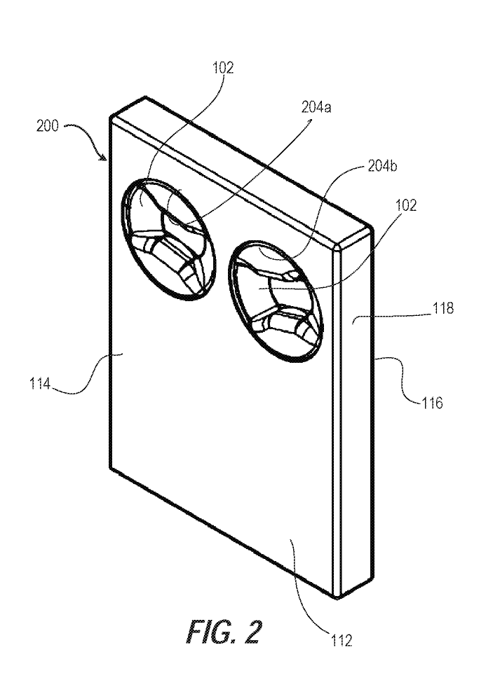

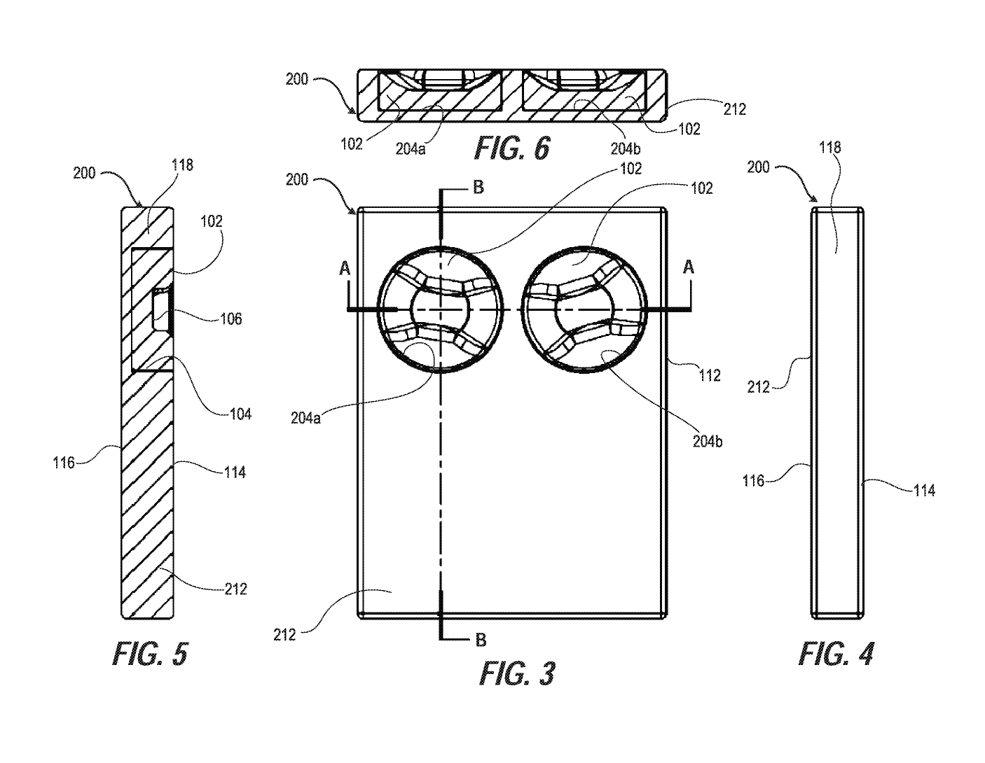

FIGS. 2-6 illustrate a perspective view of an example mattress 200 with a mattress body 212 having two inserts 102 for left and right apertures 204a, 204b for supporting two persons that are side sleepers, according to one or more embodiments. Examples of mattresses 200 that have a lateral width that is sufficient to receive two persons includes full size, queen size, king size, and custom sized.

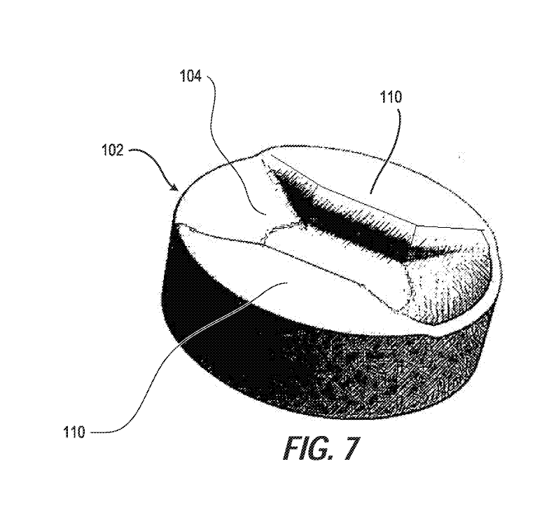

FIG. 7 illustrates the insert of FIG. 1, according to one or more embodiments. The insert 102 can be a molded foam, such as a natural latex foam. In some embodiments, the insert 102 and aperture 104 can have other geometric shapes to include a square, a rectangle, a triangle, an oval, etc.

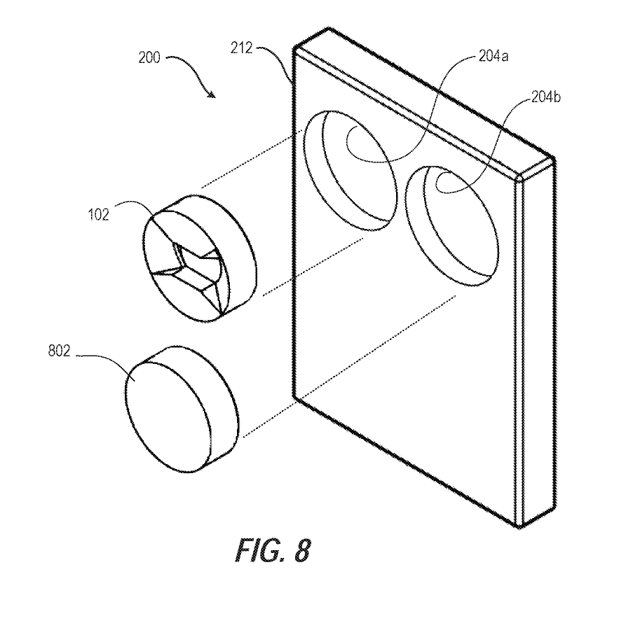

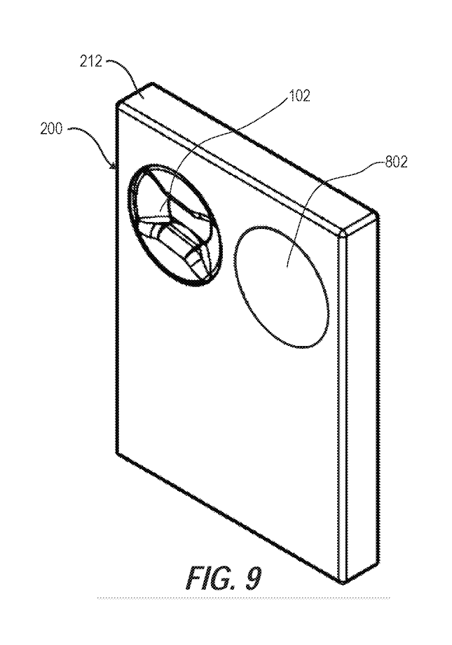

FIGS. 8-9 illustrate the mattress 200 of FIG. 2 with one insert 102 and a flat insert 802, according to one or more embodiments. One person that is not a side sleeper can sleep with a traditionally flat side of the mattress 200 by being supported by the flat insert 802.

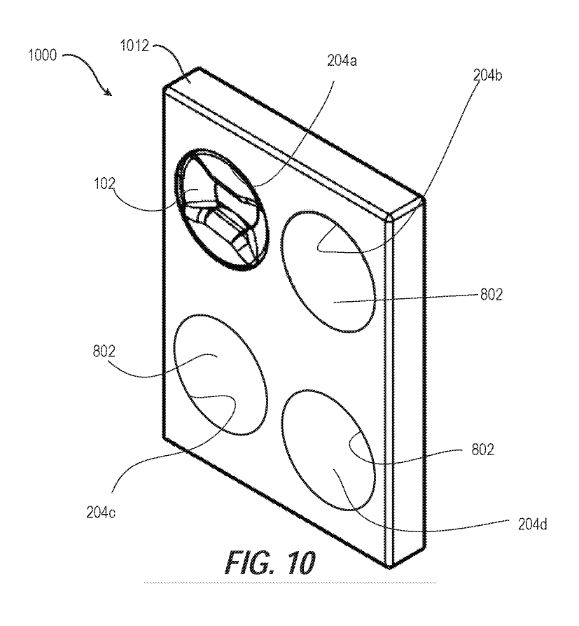

FIG. 10 illustrates another example mattress 1000 with a mattress body 1012 having four apertures 104a-104d that receive an insert 102 and three flat inserts 802, according to one or more embodiments. The additional apertures 104c-104d can allow rotating the mattress for more even wear.

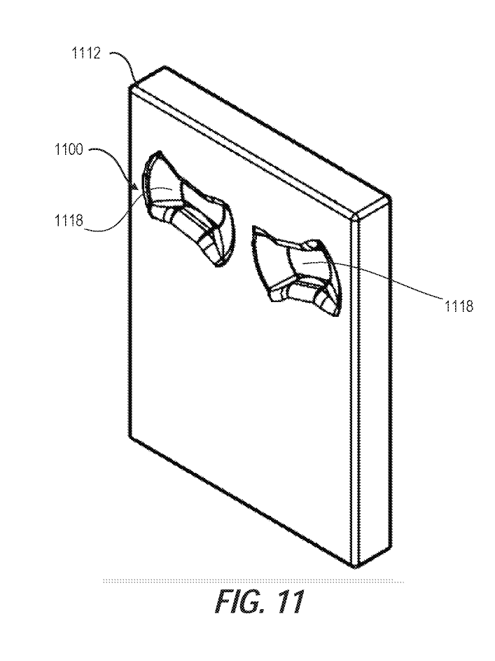

FIG. 11 illustrates a further example mattress 1100 having two trough-shaped channels 1108 formed directly into mattress body 1112, according to one or more embodiment.

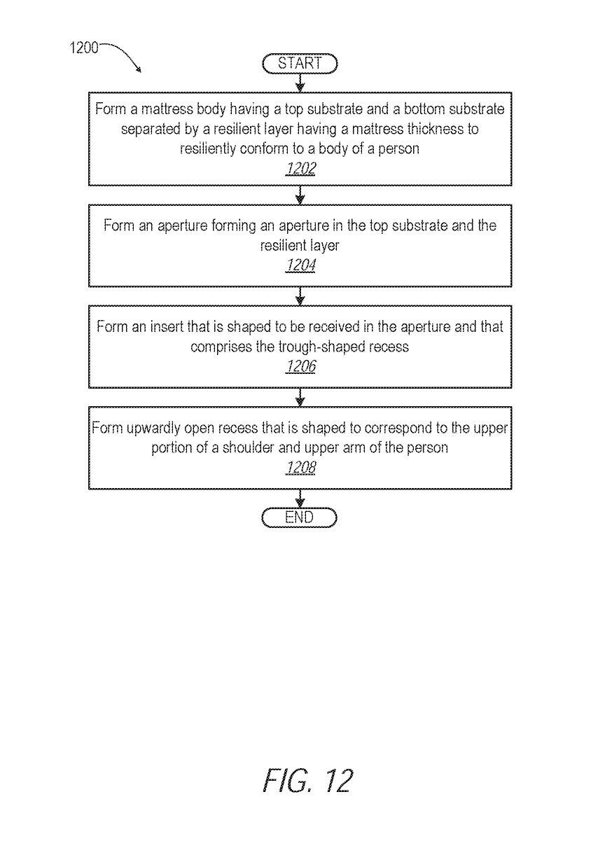

FIG. 12 illustrates a method 1200 of assembling a mattress having a trough-shaped channel for supporting a side sleeping person, according to one or more embodiments. The method 1200 includes forming a mattress body having a top substrate and a bottom substrate separated by a resilient layer having a mattress thickness to resiliently conform to a body of a person (block 1202). In various embodiments, forming the mattress body can be a selected one of an innerspring mattress, a waterbed mattress, foam mattress, and an air bed. In one embodiment, the method 1200 further includes forming an aperture forming an aperture in the top substrate and the resilient layer (block 1204). The method 1200 also includes forming an insert that is shaped to be received in the aperture and that comprises the trough-shaped recess (block 1206). The method 1200 includes forming upwardly open recess that is shaped to correspond to the upper portion of a shoulder and upper arm of the person (block 1208). Alternatively, the method includes forming the upwardly open recess directly into the mattress body.

In one embodiment, the method 1200 includes forming the aperture comprises forming the aperture through the top and bottom substrates of the mattress body to receive the insert from either side of the mattress body. For example, the insert can comprise molding natural latex foam. In one embodiment, forming the bottom substrate includes forming as a structural layer that supports and maintains vertical position of the insert.

In the above described flow chart of FIG. 12, the method may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

By virtue of the foregoing, the present disclosure provides is a mattress with a shoulder indentation component that allows for greatly reduced/negative pressure in the shoulder region. In one embodiment, shoulder indentation (both static and adjustable) within a mattress that allows for greatly reduced/negative pressure in the shoulder region, as compared to traditional mattresses. The disclosed innovation is for individuals that primarily sleep in an orientation that is perpendicular to the mattress (side sleeping) and/or have problems with spinal alignment in the upper torso/neck region and/or shoulder problems. By creating a pre-formed displacement for the shoulder, the side sleeper mattress allows for the immediate depression of the shoulder into the mattress without directly depending on the density or material of the existing traditional sleeping surfaces. By creating this indentation/depression within the mattress, the individual is able to almost entirely alleviate pressure that would normally be induced by mattresses currently available on the market.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the innovation pertains. Although a number of methods and materials similar or equivalent to those described herein can be used in the practice of the present innovation, the preferred materials and methods are described herein.

As will be appreciated by one having ordinary skill in the art, the methods and compositions of the innovation substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof

As required, detailed embodiments of the present innovation are disclosed herein; however, it is to be understood that the disclosed embodiments are merely exemplary of the innovation, which may be embodied in various forms. Therefore, specific structural and functional details disclosed herein are not to be interpreted as limiting, but merely as a basis for the claims and as a representative basis for teaching one skilled in the art to variously employ the present innovation in virtually any appropriately detailed structure.

While it is apparent that the illustrative embodiments of the innovation herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present innovation.

What is claimed is:

1. A mattress comprising:
a mattress body;
an aperture defined in the mattress body that is oriented proximate to an upper torso portion of a person; and
a contoured insert that is shaped to be received in the aperture, the contoured insert including a channel having a first portion that has a substantially constant width, a second portion at one longitudinal end of the first portion that increases in width as the channel approaches a perimeter of the contoured insert, and a second portion at an opposite longitudinal end of the first portion that increases in width as the channel approaches the perimeter of the contoured insert, the channel being dimensioned to receive an arm and a shoulder of the person.

2. The mattress of claim 1, wherein the contoured insert includes a first wedge shaped support and a second wedge shaped support and wherein the channel is defined between the first wedge shaped support and the second wedge shaped support.

3. The mattress of claim 2, wherein the mattress body includes a top substrate, wherein when the contoured insert is inserted into the aperture, the first wedge shaped support includes a first surface that is substantially on a same plane as a first surface of the top substrate and the second wedge shaped support includes a first surface that is substantially on a same plane as the first surface of the top substrate.

4. The mattress of claim 3, wherein the first wedge shaped support includes a first side wall, a second side wall, and a third side wall, wherein the second wedge shaped support includes a first side wall, a second side wall, and a third side wall, and wherein the first side wall of the first wedge shaped support is substantially parallel to the first side wall of the second wedge shaped support.

5. The mattress of claim 4, wherein the second and third side walls of the first wedge shaped support and the second and third side walls of the second wedge shaped support are angled such that the channel increases in width as the channel approaches the perimeter of the contoured insert.

6. The mattress of claim 1, wherein the first portion of the channel has an essentially constant depth, wherein the second portion and the third portion of the channel have a depth that decreases as the channel approaches the perimeter.

7. The mattress of claim 6, wherein the mattress body includes a top substrate, wherein when the contoured insert is inserted into the aperture, the first wedge shaped support includes a first surface that is substantially on a same plane as a first surface of the top substrate and the second wedge shaped support includes a first surface that is substantially on a same plane as the first surface of the top substrate.

8. The mattress of claim 7, wherein a first surface of the first portion of the channel is essentially parallel to the first surface of the first wedge shaped support, the first surface of the second wedge shaped support, and the first surface of the top substrate.

9. The mattress of claim 1, wherein the contoured insert is removable from the aperture and is rotatable in the aperture when disposed in the aperture.

10. A mattress to support a side sleeping person comprising:
a mattress body having a top substrate and a bottom substrate separated by a resilient layer having a mattress thickness to resiliently conform to a body of a person;
an aperture formed in the top substrate and the resilient layer mattress that is oriented proximate to an upper torso portion of the body of the person; and
a contoured insert that is shaped to be received in the aperture and having a channel to receive an upper portion of the body of the person.

11. The mattress of claim 10, wherein the contoured insert includes a first wedge shaped support and a second wedge shaped support and wherein the channel is defined between the first wedge shaped support and the second wedge shaped support.

12. The mattress of claim 11, wherein when the contoured insert is inserted into the aperture, the first wedge shaped support includes a first surface that is substantially on a same plane as a first surface of the top substrate and the second wedge shaped support includes a first surface that is substantially on a same plane as the first surface of the top substrate.

13. The mattress of claim 12, wherein the first wedge shaped support includes a first side wall, a second side wall, and a third side wall, wherein the second wedge shaped support includes a first side wall, a second side wall, and a third side wall, and wherein the first side wall of the first wedge shaped support is substantially parallel to the first side wall of the second wedge shaped support.

14. The mattress of claim 13, wherein the second and third side walls of the first wedge shaped support and the second and third side walls of the second wedge shaped support are angled such that the channel increases in width as the channel approaches the perimeter of the contoured insert.

15. The mattress of claim 10, wherein the first portion of the channel has an essentially constant depth, wherein the second portion and the third portion of the channel have a depth that decreases as the channel approaches the perimeter.

16. The mattress of claim 15, wherein the mattress body includes a top substrate, wherein when the contoured insert is inserted into the aperture, the first wedge shaped support includes a first surface that is substantially on a same plane as a first surface of the top substrate and the second wedge shaped support includes a first surface that is substantially on a same plane as the first surface of the top substrate.

17. The mattress of claim 16, wherein a first surface of the first portion of the channel is essentially parallel to the first surface of the first wedge shaped support, the first surface of the second wedge shaped support, and the first surface of the top substrate.

18. A method of assembling a mattress to support a side sleeping person comprising:
forming a mattress body having a top substrate, a bottom substrate, and a resilient layer disposed between the top and bottom substrate and having a mattress thickness to resiliently conform to a body of a person;
forming an aperture in the top substrate and the resilient layer and;
forming an insert that is shaped to be received in the aperture and that comprises a trough-shaped channel that is shaped to correspond to the upper portion of a shoulder and upper arm of the person.

19. The method of claim 18 further comprising forming the aperture through the bottom substrate of the mattress body to receive the insert from either side of the mattress body.

20. The method of claim 14 further comprising forming the bottom substrate as a structural layer that supports and maintains vertical position of the insert.
